(19) United States
(12) Patent Application Publication
(10) Pub. No.: US 2024/0421928 A1
(43) Pub. Date: Dec. 19, 2024

(54) SYSTEM AND METHOD FOR OVER-THE-AIR BROADCAST LINKING TO DIGITAL PODCAST CONTENT

(71) Applicant: iBiquity Digital Corporation, Columbia, MD (US)

(72) Inventor: Paul VENEZIA, Keene, NH (US)

(21) Appl. No.: 18/745,254

(22) Filed: Jun. 17, 2024

Related U.S. Application Data
(60) Provisional application No. 63/508,448, filed on Jun. 15, 2023.

(51) Int. Cl. H04H 60/48; G06F 16/68; H04H 60/44; H04H 60/91

(52) U.S. Cl. CPC H04H 60/48; G06F 16/686; H04H 60/44; H04H 60/91

(57) ABSTRACT

A method for over-the-air broadcast linking to digital podcast content is disclosed. The method includes receiving broadcast signals and metadata from a radio broadcaster and/or IP data connection and extracting an identifier from the received metadata, wherein the identifier links to a catalog of digital podcast content produced by the radio broadcaster. Further, the method includes retrieving the catalog of the digital podcast content via an external data network using the extracted identifier. Thereafter, the method includes displaying, on a user device, a link to the retrieved catalog of the digital podcast content, such that when the displayed link is selected then a list of podcasts corresponding to the retrieved catalog of the digital podcast content is rendered on the user device.

### CROSS-REFERENCE

This application is related to and claims priority to U.S. Provisional Application No. 63/508,448, filed on Jun. 15, 2023, and entitled “OVER-THE-AIR (OTA) RADIO BROADCAST PROGRAMMING RECOMMENDATIONS”, which is hereby incorporated by reference in its entirety.

### BACKGROUND

### Technical Field

The present disclosure relates to the field of media broadcasting, and particularly relates to a system and method that seamlessly links over-the-air (OTA) broadcast linking to digital podcast content.

### Description of the Related Art

In the realm of broadcasting and content delivery, traditional radio has long been a staple for delivering news, entertainment, and information to listeners. However, as technology has progressed, there has been a growing demand for more interactive and personalized content delivery methods.

One area where traditional radio falls short is in its ability to seamlessly link listeners to related, non-linear content, such as podcasts, produced by the same organization. Presently, listeners have to manually seek out podcasts on their own, often through online searches or by visiting specific podcast platforms. This manual process not only interrupts the listening experience but also limits the discoverability of related content. Furthermore, as the consumption of podcasts and other non-linear content continues to rise, there is a clear need for a more integrated and efficient method of linking broadcast radio to these supplementary materials. Without such a solution, broadcasters risk losing listeners who seek more engaging and tailored content experiences.

Therefore, there is a need for a system and method that seamlessly links the OTA broadcast to digital podcast content, providing listeners with a more enriched and interactive experience and overcoming the above-mentioned drawbacks.

### BRIEF SUMMARY

One or more embodiments are directed to a system, method, and a computer program product (hereinafter may also be termed “mechanism”) for linking over-the-air broadcast content to digital podcast content. The disclosed mechanism in the present disclosure provides an innovative solution to integrate traditional radio broadcasts with modern digital podcasting and addresses the challenge of seamlessly connecting live broadcast programs to corresponding on-demand podcast versions, allowing listeners to access a wealth of non-linear content produced by the same broadcaster.

The mechanism includes a radio receiver equipped to receive broadcast signals and accompanying metadata about the radio broadcaster via an Internet Protocol data connection. This metadata includes identifiers that are crucial for linking broadcast content to its digital counterpart. The data processor within the system extracts an identifier from the received metadata. This identifier may be a Publisher ID that may uniquely identify the radio broadcaster and is used to link to a catalog of digital podcast content produced by the broadcaster. The mechanism also includes a network interface module that utilizes the extracted identifier to retrieve the digital podcast catalog via an external IP data network. Once retrieved, the catalog of digital podcast content is displayed on the user's device through a user interface module. The user interface module ensures that users can see a link to the podcast catalog, which, when selected, renders a list of available podcasts associated with the broadcaster, providing a seamless transition from live broadcast to on-demand content. One of the significant advancements of the mechanism is its ability to handle podcast catalog data from multiple sources through an ingest pipeline. This pipeline matches and normalizes the data, creating a unified record for each podcast and its episodes. By associating a Publisher ID with each podcast, the mechanism can efficiently link the podcast to specific broadcast records, allowing users to access a consistent and comprehensive library of podcast content.

Furthermore, the mechanism features a program-level podcast linking module communicatively coupled to the data processor. The program-level podcast linking module is designed to manage the specific case where a radio program is also available as a podcast. It assigns a unique Content ID to the program, which is included in the live data object published to the user. The Content ID may uniquely identify the program that may be available as the podcast produced by the broadcaster. The user interface module then receives this live data object, containing both the Publisher ID and the Content ID, and displays two selectable buttons: one for accessing all podcasts produced by the broadcaster and another for directly linking to the podcast archive of the currently playing broadcast program.

The program-level podcast linking can be executed in two distinct designs. The first design involves the broadcaster retrieving the Content ID from a dashboard and adding it to the software that publishes live data to a data pipeline collector. The data pipeline collector then receives the live data event and ensures the Content ID persists through the live data pipeline. The second design involves matching the program name received from the broadcaster with the podcast in the broadcaster's catalog. This matching process ensures that the correct Content ID is associated with the live data event, which is then published in the live data object.

An embodiment of the present disclosure discloses the system for linking over-the-air broadcast content to digital podcast content. The system includes a radio receiver configured to receive broadcast signals and metadata from a radio broadcaster. Further, the system includes a data processor configured to extract an identifier from the received metadata, the identifier linking to a catalog of digital podcast content produced by the radio broadcaster. The identifier includes a Publisher ID that uniquely identifies the radio broadcaster. Further, the system includes an ingest pipeline to receive the catalog data from a plurality of sources and the data processor may be configured to match and normalize the received catalog data to produce a single record representing a podcast and corresponding episodes, link the podcast to a specific radio broadcaster using the Publisher ID, and associate the Publisher ID with broadcast records related to the radio broadcaster, enabling the retrieval of podcasts produced by the radio broadcaster via the network interface module.

Furthermore, the system includes a network interface module to retrieve the catalog of the digital podcast content via an external data network using the extracted identifier. Additionally, the system includes a user interface module to display, on a user device, a link to the retrieved catalog of the digital podcast content, such that when the displayed link is selected then a list of podcasts corresponding to the retrieved catalog of the digital podcast content is rendered on the user device. The user interface module displays the link through a selectable button that, when activated, displays the list of podcasts produced by the radio broadcaster.

In an embodiment, the data processor is communicatively coupled to a program-level podcast linking module to distribute a program of the radio broadcaster as the podcast, associate a unique “Content ID” with the program for linking the podcast, include a “Content ID” in live data object published to the user, such that the user interface module receives the live data object with both the Publisher ID and the Content ID, and display a first selectable button to all podcast produced by the radio broadcaster and a second selectable button linking directly to the podcast archive for the currently playing broadcast program. In one scenario, associating the unique Content ID with the program includes checking the user device for a list of linked podcasts to retrieve the Content ID for selected podcast, and adding the Content ID to a software that publishes the live data to a data pipelinedata pipeline collector, such that the data pipelinedata pipeline collector receives a live data event and persists the Content ID through a live data pipeline before publishing it in the live data object. In another scenario, associating the unique Content ID with the program includes receiving non-playing metadata from the radio broadcaster with the program name when the program starts and matching the program name with the podcast in the broadcaster's catalog.

An embodiment of the present disclosure discloses a method for linking over-the-air broadcast content to digital podcast content. The method includes the steps of receiving broadcast signals and metadata from a radio broadcaster and/or IP connection and extracting an identifier from the received metadata, the identifier linking to a catalog of digital podcast content produced by the radio broadcaster. Further, the method includes matching and normalizing the received catalog data to produce a single record representing a podcast and corresponding episodes, wherein the catalog data is received from a plurality of sources, linking the podcast to a specific radio broadcaster using the Publisher ID, and associating the Publisher ID with broadcast records related to the radio broadcaster, enabling the retrieval of podcasts produced by the radio broadcaster via the network interface module.

Next, the method includes the steps of retrieving the catalog of the digital podcast content via an external data network using the extracted identifier. Thereafter, the method includes the steps of displaying, on a user device, a link to the retrieved catalog of the digital podcast content, such that when the displayed link is selected then a list of podcasts corresponding to the retrieved catalog of the digital podcast content is rendered on the user device.

In an embodiment, the method includes the steps of distributing a program of the radio broadcaster as the podcast, associating a unique Content ID with the program for linking the podcast, including a Content ID in live data object published to the user, such that the live data object is received with both the Publisher ID and the Content ID, and displaying a first selectable button to all podcast produced by the radio broadcaster and a second selectable button linking directly to the podcast archive for the currently playing broadcast program. In one scenario, associating the unique Content ID with the program further includes the steps of checking the user device for a list of linked podcasts to retrieve the Content ID for selected podcast and adding the Content ID to a software that publishes the live data to a data pipelinedata pipeline collector, such that the data pipelinedata pipeline collector receives a live data event and persists the Content ID through live data pipeline before publishing it in the live data object. In another scenario, associating the unique Content ID with the program further includes the steps of receiving non-playing metadata from the radio broadcaster with the program name when the program starts and matching the program name with the podcast in the broadcaster's catalog.

An embodiment of the present disclosure discloses a computer program product comprising at least one non-transitory computer-readable storage medium having computer-executable program code portions stored therein. The computer program product is configured to receive broadcast signals and metadata from a radio broadcaster and/or IP connection and extract an identifier from the received metadata, the identifier linking to a catalog of digital podcast content produced by the radio broadcaster. Further, the computer program product is configured to match and normalize the received catalog data to produce a single record representing a podcast and corresponding episodes, wherein the catalog data is received from a plurality of sources, linking the podcast to a specific radio broadcaster using the Publisher ID, and associate the Publisher ID with broadcast records related to the radio broadcaster, enabling the retrieval of podcasts produced by the radio broadcaster via the network interface module.

Next, the computer program product is configured to retrieve the catalog of the digital podcast content via an external data network using the extracted identifier. Thereafter, the computer program product is configured to display, on a user device, a link to the retrieved catalog of the digital podcast content, such that when the displayed link is selected then a list of podcasts corresponding to the retrieved catalog of the digital podcast content is rendered on the user device.

In an embodiment, the computer program product is configured to distribute a program of the radio broadcaster as the podcast, associate a unique Content ID with the program for linking the podcast, and include a Content ID in live data object published to the user, such that the live data object is received with both the Publisher ID and the Content ID, and display a first selectable button to all podcast produced by the radio broadcaster and a second selectable button linking directly to the podcast archive for the currently playing broadcast program. In one scenario, associating the unique Content ID with the program further includes the steps of checking the user device for a list of linked podcasts to retrieve the Content ID for selected podcast and adding the Content ID to a software that publishes the live data to a data pipelinedata pipeline collector, such that the data pipelinedata pipeline collector receives a live data event and persists the Content ID through a live data pipeline before publishing it in the live data object. In another scenario, associating the unique Content ID with the program further includes the steps of receiving non-playing metadata from the radio broadcaster with the program name when the program starts and matching the program name with the podcast in the broadcaster's catalog.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment for a system for over-the-air broadcast linking to digital podcast content, in accordance with an embodiment of the present disclosure. I

FIG. 2 illustrates a block diagram of the system for over-the-air broadcast linking to digital podcast content, in accordance with an embodiment of the present disclosure.

FIG. 3 illustrates a flow chart for a podcast ingest pipeline relating to broadcaster linking, in accordance with an embodiment of the present disclosure.

FIG. 4 illustrates a flow chart for a client interaction with broadcaster podcast linking, in accordance with an embodiment of the present disclosure.

FIG. 5A illustrates a flow chart for a first program-level podcast linking ingest flow design, in accordance with an embodiment of the present disclosure.

FIG. 5B illustrates a flow chart for a second program-level podcast linking ingest flow design, in accordance with an embodiment of the present disclosure.

FIGS. 6A-D illustrates exemplary implementation of the system for over-the-air broadcast linking to digital podcast content, in accordance with an embodiment of the present disclosure.

FIG. 7 is a flow chart of a method for over-the-air broadcast linking to digital podcast content, in accordance with an embodiment of the present disclosure.

FIG. 8 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system, method, and a computer program product (hereinafter may also be termed “mechanism”) for linking over-the-air broadcast content to digital podcast content. The disclosed mechanism in the present disclosure provides an innovative solution to integrate traditional radio broadcasts with modern digital podcasting and addresses the challenge of seamlessly connecting live broadcast programs to corresponding on-demand podcast versions, allowing listeners to access a wealth of non-linear content produced by the same broadcaster.

The mechanism includes a radio receiver equipped to receive broadcast signals and accompanying metadata from a radio broadcaster. This metadata includes identifiers that are crucial for linking broadcast content to its digital counterpart. The data processor within the system extracts an identifier from the received metadata. This identifier, typically a Publisher ID, uniquely identifies the radio broadcaster and links to a catalog of digital podcast content produced by the broadcaster. Note that in the Figures, the term IPCPublisherID is understood to be the same in meaning and definition as the term PublisherID used herein, and the term IPCContentID is understood to be the same in meaning and definition as the term ContentID used herein. The mechanism also includes a network interface module that utilizes the extracted identifier to retrieve the digital podcast catalog via an external data network. Once retrieved, the catalog of digital podcast content is displayed on the user's device through a user interface module. The user interface module ensures that users can see a link to the podcast catalog, which, when selected, renders a list of available podcasts associated with the broadcaster, providing a seamless transition from live broadcast to on-demand content. One of the significant advancements of the mechanism is its ability to handle podcast catalog data from multiple sources through an ingest pipeline. This pipeline matches and normalizes the data, creating a unified record for each podcast and its episodes. By associating a Publisher ID with each podcast, the mechanism can efficiently link the podcast to specific broadcast records, allowing users to access a consistent and comprehensive library of podcast content.

Furthermore, the mechanism features a program-level podcast linking module communicatively coupled to the data processor. The program-level podcast linking module is designed to manage the specific cases where a radio program is also available as a podcast. It assigns a unique Content ID to the program, which is included in the live data object published to the user. The user interface module then receives this live data object, containing both the Publisher ID and the Content ID, and displays two selectable buttons: one for accessing all podcasts produced by the broadcaster and another for directly linking to the podcast archive of the currently playing broadcast program.

The program-level podcast linking can be executed in two distinct designs. The first design involves the broadcaster retrieving the Content ID from a dashboard and adding it to the software that publishes live data to a data pipeline collector. The data pipeline collector then receives the live data event and ensures the Content ID is persisted through the live data pipeline. The second design involves matching the program name received from the broadcaster with the podcast in the broadcaster's catalog. This matching process ensures that the correct Content ID is associated with the live data event, which is then published in the live data object.

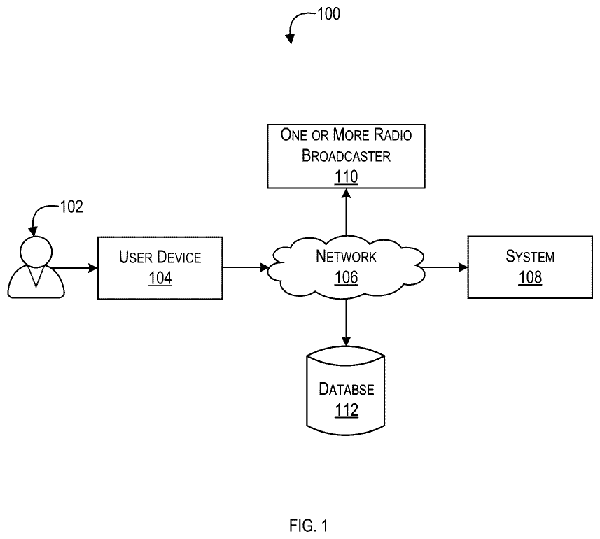

FIG. 1 illustrates an exemplary environment 100 for a system 108 for over-the-air broadcast linking to digital podcast content, in accordance with an embodiment of the present disclosure. In an embodiment, the exemplary environment 100 may include a user 102, a user device 104, a network 106, the system 108, one or more radio broadcasters 110, and a database 112. The user 102 (here forth also termed as users 102) may correspond to anyone who listens to over-the-air radio broadcasts and has access to a compatible radio receiver, such as car drivers, commuters, and radio enthusiasts. Further, the users 102 may include one or more individuals with varying interests and preferences. The one or more individuals may be characterized by their enthusiasm for discovering new audio content across diverse platforms. Additionally, or alternatively, the user 102 may include individuals who enjoy discovering new audio content and prefer seamless integration between live radio and digital podcasts. It may be noted that the system 108 may, specifically, benefit those individual(s) who want to explore additional content related to their favorite radio stations without the inconvenience of searching manually, offering a more personalized and enriched listening experience. Accordingly, the user device 104 in the system 108 may refer to any electronic device equipped with a radio receiver and a user interface capable of displaying digital content and interacting with external networks, for example modern car infotainment systems, smartphones, tablets, and smart home speakers. It may be noted that such user devices 104 may be designed to receive over-the-air radio broadcasts and metadata, process this information to extract relevant identifiers, and use network connectivity to retrieve additional content, such as podcasts. The user interface of such user devices 104 may then display the retrieved podcast links, allowing the users 102 to easily access and navigate through the digital content. By integrating traditional radio functionality with digital content accessibility, the user device 104 provides a seamless and enhanced listening experience.

In an embodiment, the network 106 (such as a communication network) may facilitate communication between the user device 104 and the system 108. Further, the network 106 may, without any limitation, include a direct interconnection, a Local Area Network (LAN), a Wide Area Network (WAN), a wireless network (e.g., using Wireless Application Protocol), the Internet, Bluetooth, Wireless Fidelity (Wi-Fi), Universal Serial Bus (USB) connectivity, or another connectivity infrastructure. The system 108 is connected with the one or more radio broadcasters 110, each of which transmits over-the-air (OTA) broadcast signals along with accompanying metadata. These broadcasters produce a variety of content, including music, talk shows, news, and special programs, and often have an associated catalog of digital podcasts. By embedding unique identifiers in the metadata, the one or more radio broadcasters 110 enable the system 108 to link the live broadcast content to corresponding digital podcasts, enhancing the reach and accessibility of their programs. Such a connection allows listeners to seamlessly transition from live radio to on-demand podcast episodes, thereby extending the broadcasters' engagement with their audience across multiple platforms. The system 108 is also communicatively coupled, via the network 106, to the database 112 that is configured to store a comprehensive catalog of digital podcast content produced by various radio broadcasters 110. The database 112 facilitates the system 108 to query using unique identifiers extracted from broadcast metadata, such as Publisher ID and Content ID. The Publisher ID may uniquely identify the radio broadcaster and links to a catalog of digital podcast content produced by the broadcaster. Further, the Content ID may uniquely identify the program that may be available as the podcast produced by the broadcaster. Additionally, the database 112 holds detailed information about each podcast, including episodes and associated metadata, ensuring that when the user 102 tunes into a broadcast, the system 108 can retrieve and display relevant podcast links seamlessly.

In operation, initially, the system 108 may tune into over-the-air (OTA) radio broadcasts, capturing both the broadcast signals and accompanying metadata containing unique identifiers such as Publisher ID, which identifies the broadcaster, and Content ID, which is linked to specific programs available as podcasts. Next, the system 108 may extract such identifiers and connect the extracted identifiers to an external data network for facilitating communication with the database 112 that houses a comprehensive catalog of podcasts produced by various broadcasters. Upon extracting the identifiers, the system 108 may query the database 112 to retrieve the relevant podcast catalog and the database 112 may respond with detailed information about the podcasts, including links to all podcasts produced by the radio broadcaster 110 (identified by Publisher ID) and specific episodes of the current program (identified by Content ID). Such an information is then rendered onto the user device 104, such as a car's infotainment system, a smartphone, a tablet, or a smart speaker. In addition, the system 108 also displays interactive links or buttons on the user device 104. Typically, two types of links are presented: one that provides access to all podcasts produced by the radio broadcaster 110 and another that directs the user 102 to the podcast archive for the currently playing program. When the user 102 selects one of these links, the system 108 facilitates the playback of the chosen podcast, providing a seamless transition from live radio to on-demand digital content. This process enhances the user's listening experience by effortlessly integrating traditional radio with digital podcasts, allowing the user 102 to discover and enjoy additional content related to their favorite radio broadcasts.

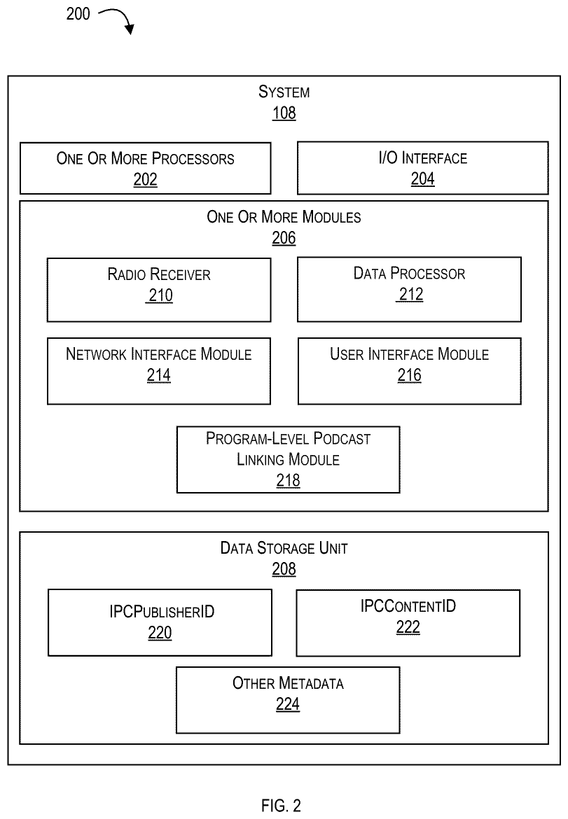

FIG. 2 illustrates a block diagram of the system 108 for over-the-air broadcast linking to digital podcast content, in accordance with an embodiment of the present disclosure.

In an embodiment, the system 108 may include one or more processors 202, an Input/Output (I/O) interface 204, one or more modules 206, and a data storage unit 208. The one or more processors 202 may be implemented as one or more microprocessors microcomputers, microcomputers, digital signal processors, central processing units, state machines, logic circuitries, and/or any devices that manipulate signals based on operational instructions. Further, the I/O interface 204 may serve as the pivotal bridge connecting the internal processes of the system 106 with its external environment for facilitating the exchange of information between the system 106 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a radio receiver 210, a data processor 212, a network interface module 214, a user interface module 216, a program-level podcast linking module 218, and any other module essential or required for the working of the system 108. In an embodiment, the data storage unit 208 may include the Publisher ID 220, Content ID 222, and other metadata 224 required for the working of the system 108. In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. In an example, the data storage unit 208 may be internal to the system 108, such as an onside-based storage. In another example, the data storage unit 208 may be external to the system 108, such as cloud-based storage. Further, the one or more module 206 may be communicatively coupled to the data storage unit 208 and the one or more processor 202 of the system 108. The one or more processors 202 may be configured to control the operations of the one or more modules 206.

In an embodiment, the radio receiver 210 may receive over-the-air (OTA) broadcast signals from the radio broadcaster 110. The radio receiver 210 may be equipped to capture not only the audio content but also the accompanying metadata that the radio broadcasters 110 may embed within the transmissions. The metadata may, without any limitation, include unique identifiers such as Publisher ID 220, which uniquely identifies the broadcaster, and Content ID 222, which is linked to specific programs or segments that may also be available as podcasts.

In an embodiment, the data processor 212 may be responsible for managing and interpreting the metadata received from the radio receiver 210. Upon receiving the broadcast signal and accompanying metadata, the data processor 212 may extract unique identifiers such as Publisher ID 220 and Content ID 222. Further, the extracted unique identifiers may be crucial for linking the live radio content to its corresponding digital podcasts. The data processor 212 may perform several key functions such as decoding the metadata, processing the identifiers, and preparing them for use by the network interface module 214. The system 108 may include an ingest pipeline, as may be explained in detail in the following paragraphs, to receive the catalog data from a plurality of sources, such that the data processor 212 may match and normalize the received catalog data to produce a single record representing a podcast and corresponding episodes. Then, the data processor 212 may link the podcast to a specific radio broadcaster using the Publisher ID 220. Thereafter, the data processor 212 may associate the Publisher ID 220 with broadcast records related to the radio broadcaster, enabling the retrieval of podcasts produced by the radio broadcaster 110 via the network interface module 214. Accordingly, the data processor 212 may normalize and match catalog data from multiple sources, ensuring consistency and accuracy in the records representing podcasts and episodes. By integrating these identifiers into the system 108, the data processor 212 enables seamless communication with the database 112, facilitating the retrieval of relevant podcast information.

In an embodiment, the network interface module 214 may retrieve the catalog of the digital podcast content via an external data network using the extracted identifier. The network interface module 214 may enable seamless connectivity between the radio receiver 210, the database 112, and the user device 104. Upon receiving unique identifiers such as Publisher ID 220 and Content ID 222 from the data processor 212, the network interface module 214 utilizes these identifiers to query the database 112 over the network 106, typically the internet. The network interface module 214 may ensure secure and efficient communication, retrieving detailed information about the digital podcast content produced by the radio broadcasters 110. By leveraging network protocols and connectivity standards, the network interface module 214 may access a vast catalog of podcasts, ensuring that the system 108 may have the most up-to-date content. Once the relevant podcast data is retrieved, the network interface module 214 may forward it to the user interface module 206. This real-time data transfer capability may be crucial for providing the users 102 with instantaneous access to related podcast content while they listen to live radio broadcasts.

In an embodiment, the user interface module 216 serves as the bridge between the system 108 and the user 102, facilitating interaction and enhancing the overall user experience. It is responsible for rendering and presenting information to the user 102 on the user device 104. Upon receiving podcast data from the network interface module 214, the user interface module 216 formats this information into a user-friendly interface, typically displaying clickable buttons or links. These buttons allow users to access additional digital podcast content related to the live radio broadcasts they are listening to. The user interface module 216 may ensure that the displayed content is intuitive, visually appealing, and responsive to user interactions. It may also incorporate features such as search functionality, filtering options, and personalized recommendations to further enhance user engagement. Typically, the user interface module 216 may display, on the user device 104, a link to the retrieved catalog of the digital podcast content, such that when the displayed link is selected then a list of podcasts corresponding to the retrieved catalog of the digital podcast content is rendered on the user device 104. Further, the user interface module 216 may display the link through a selectable button that, when activated, displays the list of podcasts produced by the radio broadcaster 110.

In an embodiment, the program-level podcast linking module 218 may be communicatively coupled to the data processor 212. Further, the program-level podcast linking module 218 may distribute a program of the radio broadcaster 110 as the podcast, and associate the unique Content ID 222 with the program for linking the podcast. After association, the program-level podcast linking module 218 may include the Content ID 222 in live data object published to the user, such that the user interface module 216 receives the live data object with both the Publisher ID 220 and the Content ID 222 and display a first selectable button to all podcast produced by the radio broadcaster and a second selectable button linking directly to the podcast archive for the currently playing broadcast program. In one scenario, associating the unique Content ID 222 with the program may further include checking the user device for a list of linked podcasts to retrieve the Content ID 222 for selected podcast. After checking, the Content ID 222 may be added to a software that publishes the live data to a data pipeline collector, such that the data pipeline collector receives a live data event and persists the Content ID 222 through a live data pipeline before publishing it in the live data object. In another scenario, associating the unique Content ID 222 with the program may further include receiving non-playing metadata from the radio broadcaster with the program name when the program starts and matching the program name with the podcast in the broadcaster's catalog.

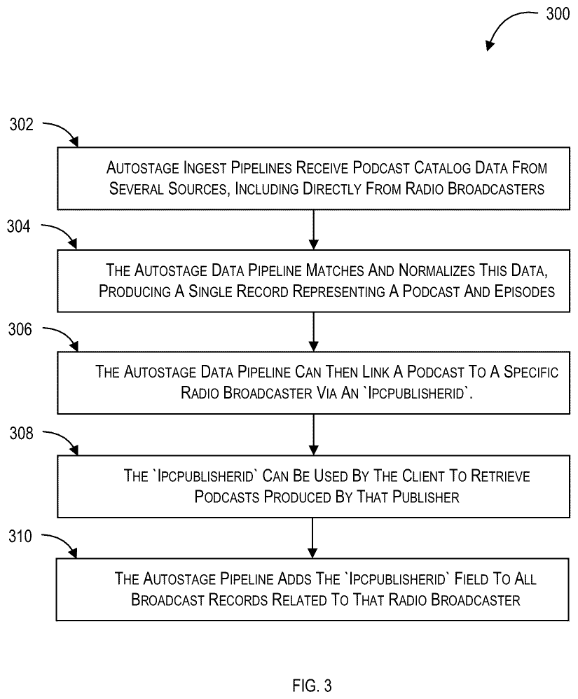

FIG. 3 illustrates a flow chart 300 for a podcast ingest pipeline relating to broadcaster linking, in accordance with an embodiment of the present disclosure. At first, podcast catalog data may be received from several sources including directly from the radio broadcaster, at step 302. For example, consider a radio broadcaster named “Wave FM” that produces various radio programs and podcasts. The AutoStage™ ingest pipeline may receive podcast catalog data from Wave FM, including information about each podcast episode, such as title, description, and publication date. Next, at step 304, the data may be matched and normalized to produce a single record representing a podcast and episodes. For example, within the AutoStage pipeline, the data may be matched and normalized to ensure consistency across different sources. For instance, if Wave FM provides podcast catalog data in different formats or with varying naming conventions, the pipeline standardizes this information into a unified format. Next, at step 306, a podcast may be linked to a specific radio broadcaster via the Publisher ID. For example, each podcast in the catalog is linked to its respective radio broadcaster using a unique identifier, such as a Publisher ID assigned to Wave FM. This linkage may ensure that the system can correlate live radio broadcasts with relevant podcast content. Next, at step 308, the Publisher ID may be used by the user to retrieve podcasts produced by that publisher. For example, once the linkage is established, the AutoStage pipeline may add the Publisher ID field to all broadcast records related to Wave FM. This field serves as a reference point for identifying the broadcaster associated with each radio program. Thereafter, at step 310, the Publisher ID may be added to all broadcast records related to that radio broadcaster. Accordingly, the Autostage pipeline may create a seamless connection between radio broadcasters like Wave FM and their digital podcast content. This linkage may enable the users to access podcasts produced by their favorite radio stations, enhancing their listening experience and expanding the reach of the broadcasters' content across different platforms.

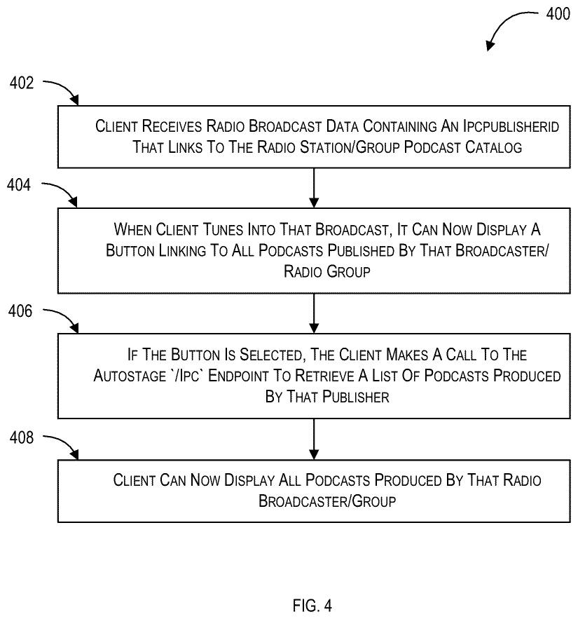

FIG. 4 illustrates a flow chart 400 for a client interaction with broadcaster podcast linking, in accordance with an embodiment of the present disclosure. At first, radio broadcast data containing a Publisher ID may be received by the client, at step 402, that may link to the radio station/group podcast catalog. For example, imagine a user, Sarah, listening to a live radio broadcast from “Sunrise Radio.” As part of the broadcast metadata, the radio station may embed a Publisher ID that uniquely identifies Sunrise Radio as the radio broadcaster. Next, at step 404, a button linking to all podcasts by that broadcaster/radio group may be displayed when the client tunes into that broadcast. For example, Sarah's car infotainment system recognizes the Publisher ID embedded in the broadcast data and displays a button on the dashboard screen labeled “Explore Podcasts by Sunrise Radio.” This button serves as a direct link to the podcast content associated with Sunrise Radio. Next, at step 406, if the button is selected, a list of podcasts produced by that publisher may be retrieved by the client making a call to the Autostage “/IPC” endpoint. For example, intrigued by the podcast linking button, Sarah taps on it using the touchscreen interface of her car's dashboard. This action triggers a request to the system's backend to retrieve the podcast catalog associated with Sunrise Radio. Upon receiving Sarah's request, the system's network interface module initiates a call to the AutoStage/ipc endpoint. This endpoint is designed to fetch a list of podcasts produced by the broadcaster identified by the Publisher ID (in this case, Sunrise Radio). Further, the AutoStage/ipc endpoint retrieves the podcast catalog for Sunrise Radio from the central database. This catalog includes a collection of podcasts produced by the radio station, along with relevant metadata such as titles, descriptions, and publication dates. Thereafter, at step 408, all podcasts produced by that radio broadcaster/group may not be displayed. For example, the retrieved podcast list is presented to Sarah on her car's dashboard screen. She can now browse through the available podcasts and select any that pique her interest, such as interviews, music shows, or talk segments.

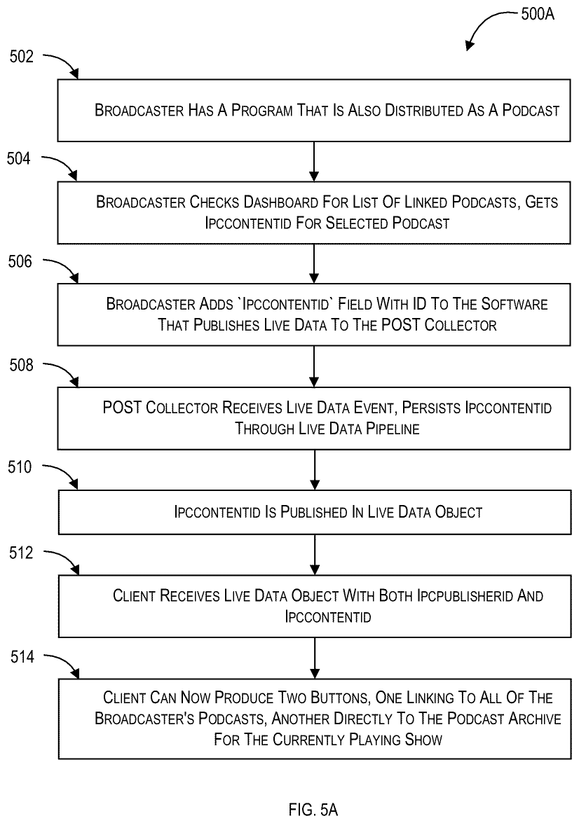

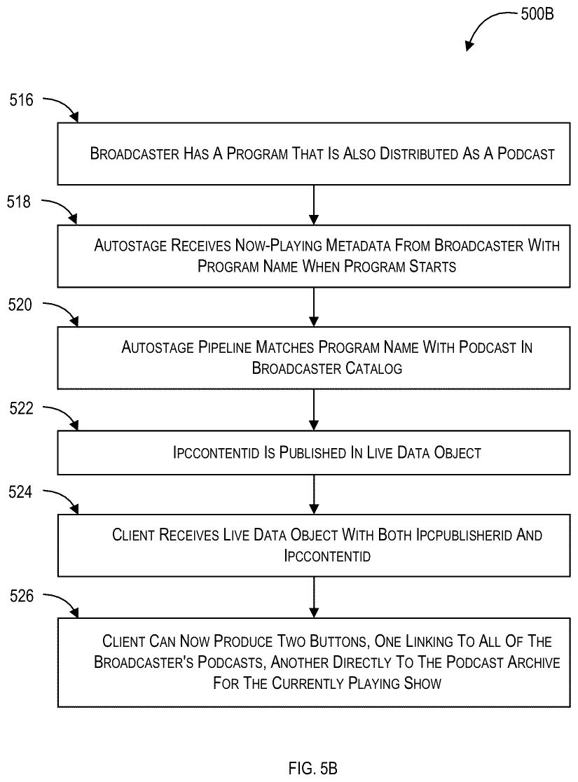

FIG. 5A illustrates a flow chart 500A for a first program-level podcast linking ingest flow design, in accordance with an embodiment of the present disclosure. At first, at step 502, the broadcaster may have a program also distributed as a podcast. For example, a radio station, “Metro Radio,” airs a popular morning show called “The Morning Buzz.” This show is also available as a podcast that listeners can access on-demand. Next, at step 504, broadcaster checks Dashboard for linked podcasts and retrieves Content ID. For example, the program manager at Metro Radio logs into the content management dashboard provided by the system. They check the list of linked podcasts and find the corresponding podcast for “The Morning Buzz.” The dashboard displays a unique identifier, Content ID, for this podcast. Next, at step 506, Content ID is added to software that publishes live data. For example, the program manager enters the Content ID into the radio station's broadcasting software. This software is responsible for publishing live data events related to the radio broadcast. Next, at step 508, data pipeline collector receives live data event, and persists Content ID. For example, when “The Morning Buzz” goes live, the broadcasting software sends live data events, including the Content ID, to the data pipeline collector. The data pipeline collector captures this live data and ensures that the Content ID is associated with the live broadcast data throughout the data pipeline. Next, at step 510, Content ID is published in live data object. For example, the live data object, now containing the Content ID, is processed and published through the system's data pipeline. This object is made available to any client devices tuned into Metro Radio. Next, at step 512, client receives live data object with both Publisher ID and Content ID. For example, Sarah, a listener, tunes into Metro Radio using her car's infotainment system. The system receives the live broadcast along with the live data object, which includes both the Publisher ID (identifying Metro Radio) and the Content ID (identifying “The Morning Buzz” podcast). Thereafter, at step 514, buttons for podcasts may be displayed on user interface. For example, on Sarah's infotainment screen, the user interface module displays two buttons: one labeled “All Podcasts by Metro Radio” and another labeled “The Morning Buzz Podcast Archive.” Sarah can choose to explore all podcasts produced by Metro Radio or go directly to the podcast archive for the current show.

FIG. 5B illustrates a flow chart 500B for a second program-level podcast linking ingest flow design, in accordance with an embodiment of the present disclosure. At first, at step 516, broadcaster has a program also distributed as a podcast. For example, a radio station, “City FM,” airs a popular talk show called “Evening Talks.” This show is also available as a podcast for listeners to access on-demand. Next, at step 518, AutoStage receives now-playing metadata from broadcaster with program name. For example, when “Evening Talks” starts broadcasting live, City FM's broadcasting system sends now-playing metadata, including the program name, to the AutoStage system. This metadata indicates that “Evening Talks” is currently being aired. Next, at step 520, AutoStage pipeline matches program name with podcast in broadcaster catalog. For example, the AutoStage pipeline processes the now-playing metadata and matches the program name “Evening Talks” with the corresponding podcast in City FM's podcast catalog. The system identifies that “Evening Talks” is available as a podcast and retrieves the associated Content ID. Next, at step 522, Content ID is published in live data object. For example, the live data object, now containing the Content ID for “Evening Talks,” is processed and published through the system's data pipeline. This object is made available to client devices tuned into City FM. Next, at step 524, client receives live data object with both Publisher ID and Content ID Example: John, a listener, is tuned into City FM using his smart speaker. The system receives the live broadcast along with the live data object, which includes both the Publisher ID (identifying City FM) and the Content ID (identifying “Evening Talks” podcast). Thereafter, at step 526, buttons for podcasts may be displayed on user interface. For example, on John's smart speaker interface, the user interface module displays two buttons: one labeled “All Podcasts by City FM” and another labeled “Evening Talks Podcast Archive.” John can choose to explore all podcasts produced by City FM or go directly to the podcast archive for the current show.

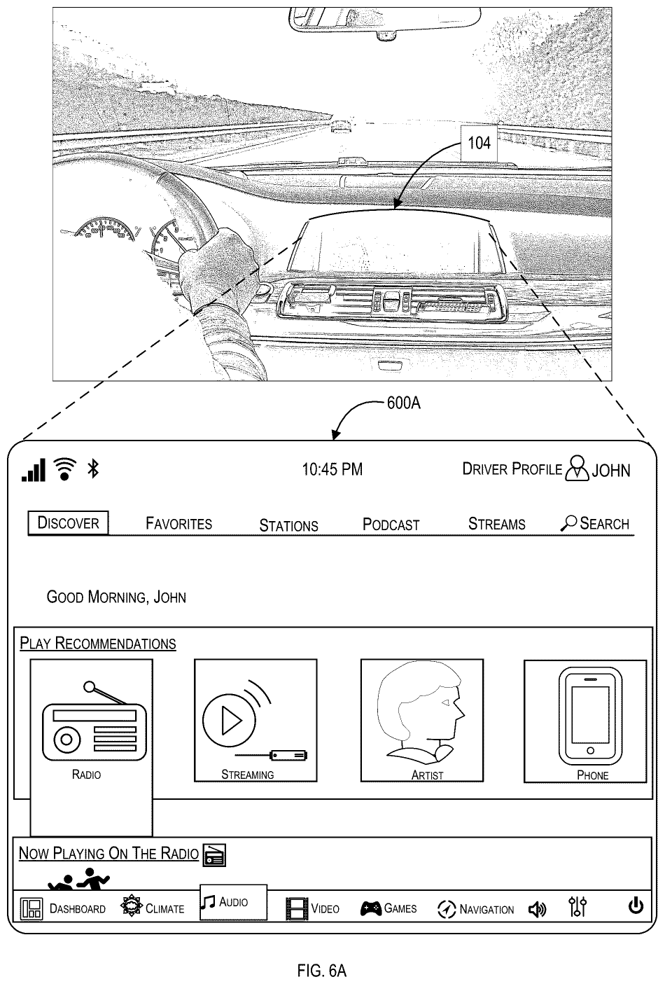

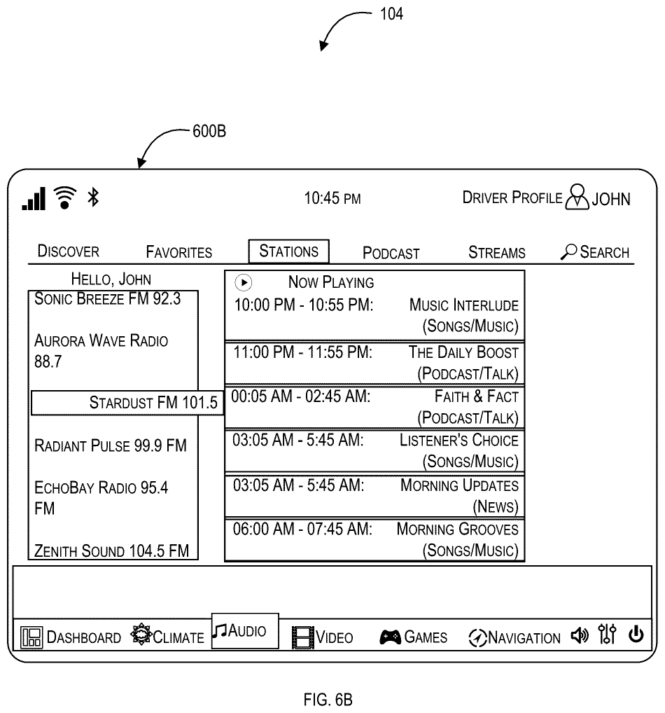

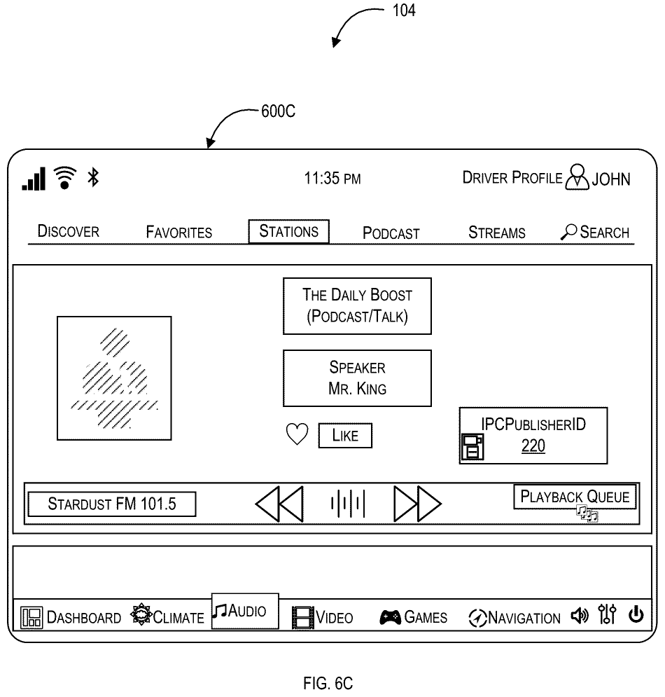

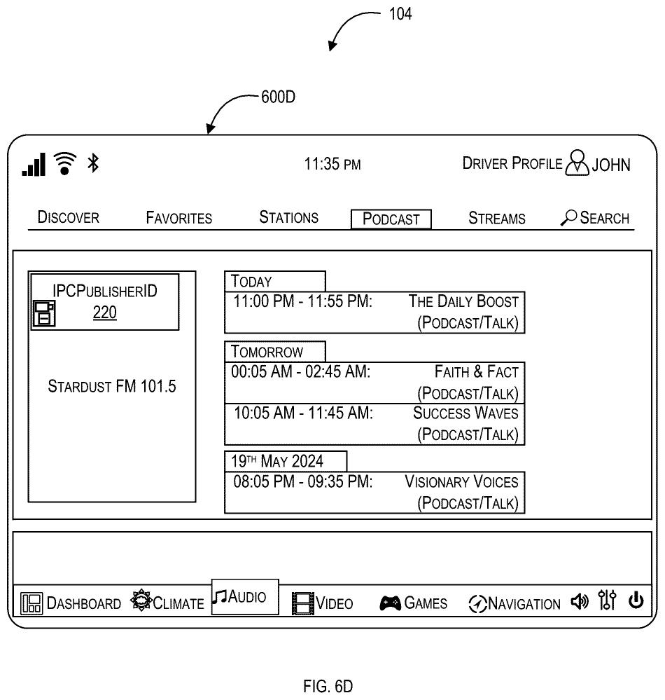

FIGS. 6A-D illustrates exemplary implementation of the system 108 for over-the-air broadcast linking to digital podcast content, in accordance with an embodiment of the present disclosure. For the sake of brevity, FIGS. 6A-D have been explained together.

As shown in FIG. 6A, the user device 104, i.e., the vehicle dashboard, may display the user's profile with various options, such as stations, podcasts, recommendations, or the like. Further, the user 102 may have a choice to select the radio to listen to, a streaming service, an artist, or the like. Furthermore, as illustrated in the user interface 600A, the user 102 may select the radio, such that the user device 104 may start playing the radio and may render corresponding icons on the interface such as “now playing on the radio”. After the user 102 selects the radio option for playing, the user 102 may be facilitated to select from the one or more radio broadcasters/stations 110. For example, as illustrated in user interface 600B, the radio broadcasters 110 may be “Sonic Breeze FM92.3”, “Aurora Wave Radio 88.7”, “Stardust FM 101.5”, “Radiant Pulse 99.9 FM”, “EchoBay Radio 95.4 FM”, and “Zenith Sound 104.5 FM”. Furthermore, the user 102 may select the radio broadcaster “Stardust FM 101.5” to view the corresponding programs, songs, podcasts, and/or news.

Furthermore, the user 102 may select a program for playing, as shown by the user interface 600C in FIG. 6C, such as the “daily boost”. When a certain program is played on the user device 104, then the user interface may also render metadata corresponding to the program. As part of the broadcast metadata, the radio station may embed the Publisher ID 220 that uniquely identifies Stardust FM 101.5 as the radio broadcaster along with the singer/speaker/anchor name, etc. Such Publisher ID may be displayed as a button linking to all podcasts by that broadcaster/radio group that may be displayed when the user tunes into that broadcast. For example, as illustrated, John's car infotainment system recognizes the Publisher ID embedded in the broadcast data and displays a button on the dashboard screen labeled “Publisher ID” that serves as a direct link to the podcast content associated with Stardust FM 101.5, as shown by user interface 600D in FIG. 6D. As illustrated, the user interface 600D displays a list of podcasts produced by the selected publisher that may be retrieved by the user 102 making a call to the Autostage “/IPC” endpoint. For example, intrigued by the podcast linking button, John taps on it using the touchscreen interface of his car's dashboard. This action triggers a request to the system's backend to retrieve the podcast catalog associated with Stardust FM 101.5. Upon receiving John's request, the system's network interface module initiates a call to the AutoStage/ipc endpoint. This endpoint is designed to fetch a list of podcasts produced by the broadcaster identified by the Publisher ID (in this case, Stardust FM 101.5). Further, the AutoStage/ipc endpoint retrieves the podcast catalog for Stardust FM 101.5 from the central database. This catalog includes a collection of podcasts produced by the radio station, along with relevant metadata such as titles, descriptions, and publication dates.

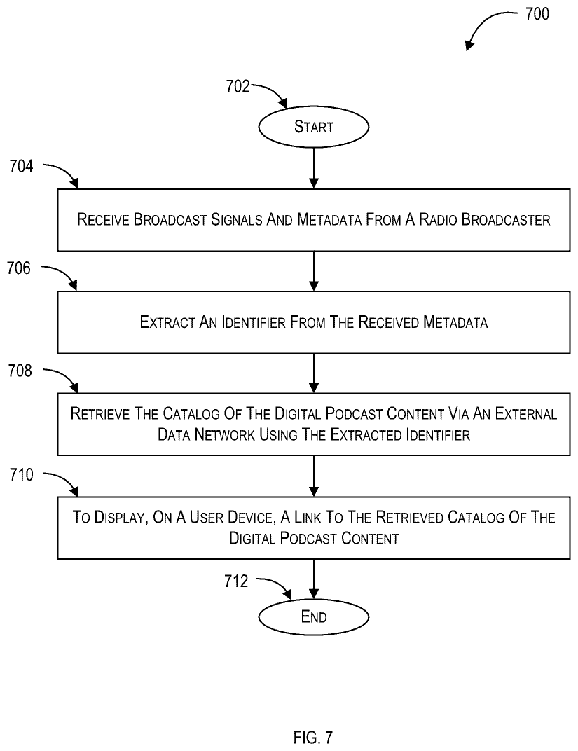

FIG. 7 is a flow chart 700 of a method for over-the-air broadcast linking to digital podcast content, in accordance with an embodiment of the present disclosure. The method starts at step 702.

At first, broadcast signals and metadata may be received from a radio broadcaster, at step 704. Next, at step 706, an identifier may be extracted from the received metadata. The identifier links to a catalog of digital podcast content produced by the radio broadcaster. The identifier may include a Publisher ID that uniquely identifies the radio broadcaster. The method may also include the steps of matching and normalizing the received catalog data to produce a single record representing a podcast and corresponding episodes, wherein the catalog data is received from a plurality of sources. Further, the method includes the steps of linking the podcast to a specific radio broadcaster using the Publisher ID and associating the Publisher ID with broadcast records related to the radio broadcaster, enabling the retrieval of podcasts produced by the radio broadcaster.

Next, at step 708, the catalog of the digital podcast content may be retrieved via an external data network using the extracted identifier. Thereafter, at step 710, a link to the retrieved catalog of the digital podcast content may be displayed on a user device, such that when the displayed link is selected, a list of podcasts corresponding to the retrieved catalog of the digital podcast content is rendered on the user device. The method also includes the steps of displaying the link through a selectable button that, when activated, displays the list of podcasts produced by the radio broadcaster.

In an embodiment, the method also includes the steps of distributing a program of the radio broadcaster as the podcast and associating a unique Content ID with the program for linking the podcast. Thereafter, the method includes the steps of including Content IDa “content Id” in live data object published to the user, such that the live data object is received with both the Publisher ID and the Content ID and displaying a first selectable button to all podcast produced by the radio broadcaster and a second selectable button linking directly to the podcast archive for the currently playing broadcast program. In one scenario, associating the unique Content ID with the program further includes the steps of checking the user device for a list of linked podcasts to retrieve the Content ID for selected podcast and adding the Content ID to a software that publishes the live data to a data pipeline collector, such that the data pipeline collector receives a live data event and persists the Content ID through a live data pipeline before publishing it in the live data object. In another scenario, associating the unique Content ID with the program further includes the steps of receiving non-playing metadata from the radio broadcaster with the program name when the program starts and matching the program name with the podcast in the broadcaster's catalog. The method ends at step 712.

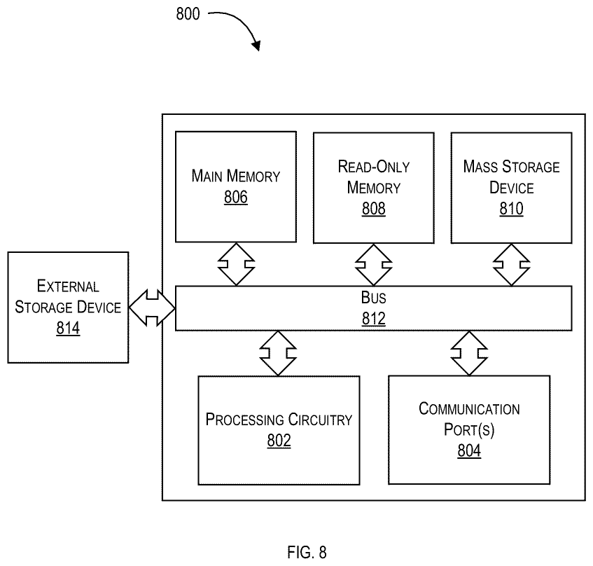

FIG. 8 illustrates an exemplary computer system in which or with which embodiments of the present disclosure may be utilized. As shown in FIG. 8, a computer system 800 includes an external storage device 814, a bus 812, a main memory 806, a read-only memory 808, a mass storage device 810, a communication port 804, and a processor 802.

Those skilled in the art will appreciate that computer system 800 may include more than one processor 802 and communication ports 804. Examples of processor 802 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 802 may include various modules associated with embodiments of the present disclosure.

The communication port 804 can be any of an RS-232 port for use with a modem-based dialup connection, a 10/100 Ethernet port, a Gigabit or 10 Gigabit port using copper or fiber, a serial port, a parallel port, or other existing or future ports. The communication port 804 may be chosen depending on a network, such as a Local Area Network (LAN), Wide Area Network (WAN), or any network to which the computer system connects.

The memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 802.

The mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 812 communicatively couples processor(s) 802 with the other memory, storage, and communication blocks. The bus 812 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 802 to a software system.

Optionally, operator and administrative interfaces, e.g., a display, keyboard, and a cursor control device, may also be coupled to bus 812 to support direct operator interaction with the computer system. Other operator and administrative interfaces can be provided through network connections connected through communication port 804. An external storage device 814 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system and method (together termed as ‘disclosed mechanism’) for dynamic content adaptation for safe driving overcomes the drawbacks of the present technologies and offers several other advantages in enhancing driving safety and reducing distractions caused by media content in the vehicles. By analyzing vehicle driving data and correlating it with media content metadata, the mechanism can proactively identify potentially dangerous content which allows for the modification or blocking of such content before it is played, reducing the risk of distractions and unsafe driving behaviors. Further, the mechanism's ability to dynamically adapt media content based on driving conditions promotes a safer driving environment. For example, the system can adjust the volume or speed of media content to minimize distractions without completely stopping the entertainment experience. This ensures that drivers remain engaged with the infotainment system while staying focused on the road. Additionally, the database of dangerous driving parameters and corresponding media content types can be continuously updated and refined which means that the mechanism can adapt to new types of media content or driving behaviors, ensuring that it remains effective in mitigating distractions and promoting safe driving practices over time. Overall, the mechanism's combination of data analysis, content identification, and adaptive control mechanisms offers a comprehensive solution for enhancing driving safety in vehicles with infotainment systems. It addresses the challenge of balancing entertainment and safety by providing a dynamic and proactive approach to managing media content during journeys.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art

What is claimed is:

1. A system for linking over-the-air broadcast content to digital podcast content, the system comprising:
a radio receiver configured to receive broadcast signals and metadata from a radio broadcaster with or without an IP data connect;
a data processor configured to extract an identifier from the received metadata, wherein the identifier links to a catalog of digital podcast content produced by the radio broadcaster;
a network interface module to retrieve the catalog of the digital podcast content via an external data network using the extracted identifier; and
a user interface module to display, on a user device, a link to the retrieved catalog of the digital podcast content, such that when the displayed link is selected then a list of podcasts corresponding to the retrieved catalog of the digital podcast content is rendered on the user device.

2. The system of claim 1, wherein the identifier comprises a Publisher ID that uniquely identifies the radio broadcaster.

3. The system of claim 2, further comprises an ingest pipeline to receive the catalog data from a plurality of sources, wherein the data processor is configured to:
match and normalize the received catalog data to produce a single record representing a podcast and corresponding episodes;
link the podcast to a specific radio broadcaster using the Publisher ID; and
associate the Publisher ID with broadcast records related to the radio broadcaster, enabling the retrieval of podcasts produced by the radio broadcaster via the network interface module.

4. The system of claim 1, wherein the user interface module displays the link through a selectable button that, when activated, displays the list of podcasts produced by the radio broadcaster.

5. The system of claim 1, wherein the data processor is communicatively coupled to a program-level podcast linking module to:
distribute a program of the radio broadcaster as the podcast;
associate a unique Content ID with the program for linking the podcast;
include Content IDa “content Id” in live data object published to the user, such that the user interface module receives the live data object with both the Publisher ID and the Content ID; and
display a first selectable button to all podcast produced by the radio broadcaster and a second selectable button linking directly to the podcast archive for the currently playing broadcast program.

6. The system of claim 5, wherein associating the unique Content ID with the program further comprises:
checking the user device for a list of linked podcasts to retrieve the Content ID for selected podcast; and
adding the Content ID to a software that publishes the live data to a data pipeline collector, such that the data pipeline collector receives a live data event and persists the Content ID through a live data pipeline before publishing it in the live data object.

7. The system of claim 5, wherein associating the unique Content ID with the program further comprises:
receiving non-playing metadata from the radio broadcaster with the program name when the program starts; and
matching the program name with the podcast in the broadcaster's catalog.

8. A method for linking over-the-air broadcast content to digital podcast content, the method comprising:
receiving broadcast signals and metadata from a radio broadcaster;
extracting an identifier from the received metadata, wherein the identifier links to a catalog of digital podcast content produced by the radio broadcaster;
retrieving the catalog of the digital podcast content via an external data network using the extracted identifier; and
displaying, on a user device, a link to the retrieved catalog of the digital podcast content, such that when the displayed link is selected then a list of podcasts corresponding to the retrieved catalog of the digital podcast content is rendered on the user device.

9. The method of claim 8, wherein the identifier comprises a Publisher ID that uniquely identifies the radio broadcaster.

10. The method of claim 9, further comprises:
matching and normalizing the received catalog data to produce a single record representing a podcast and corresponding episodes, wherein the catalog data is received from a plurality of sources;
linking the podcast to a specific radio broadcaster using the Publisher ID; and
associating the Publisher ID with broadcast records related to the radio broadcaster, enabling the retrieval of podcasts produced by the radio broadcaster.

11. The method of claim 8, further comprises displaying the link through a selectable button that, when activated, displays the list of podcasts produced by the radio broadcaster.

12. The method of claim 8, further comprises:
distributing a program of the radio broadcaster as the podcast;
associating a unique Content ID with the program for linking the podcast;
including Content IDa “content Id” in live data object published to the user, such that the live data object is received with both the Publisher ID and the Content ID; and
displaying a first selectable button to all podcast produced by the radio broadcaster and a second selectable button linking directly to the podcast archive for the currently playing broadcast program.

13. The method of claim 12, wherein associating the unique Content ID with the program further comprises:
checking the user device for a list of linked podcasts to retrieve the Content ID for selected podcast; and
adding the Content ID to a software that publishes the live data to a data pipeline collector, such that the data pipeline collector receives a live data event and persists the Content ID through a live data pipeline before publishing it in the live data object.

14. The method of claim 12, wherein associating the unique Content ID with the program further comprises:
receiving non-playing metadata from the radio broadcaster with the program name when the program starts; and
matching the program name with the podcast in the broadcaster's catalog.

15. A computer program product comprising at least one non-transitory computer-readable storage medium having computer-executable program code portions stored therein, the computer program product configured to:
receive broadcast signals and metadata from a radio broadcaster and/or IP data connection;
extract an identifier from the received metadata, wherein the identifier links to a catalog of digital podcast content produced by the radio broadcaster;
retrieve the catalog of the digital podcast content via an external data network using the extracted identifier; and
display, on a user device, a link to the retrieved catalog of the digital podcast content, such that when the displayed link is selected then a list of podcasts corresponding to the retrieved catalog of the digital podcast content is rendered on the user device.

16. The computer program product of claim 15, further configured to:
match and normalize the received catalog data to produce a single record representing a podcast and corresponding episodes, wherein the catalog data is received from a plurality of sources;
link the podcast to a specific radio broadcaster using the Publisher ID; and
associate the Publisher ID with broadcast records related to the radio broadcaster, enabling the retrieval of podcasts produced by the radio broadcaster via the network interface module.

17. The computer program product of claim 15, further configured to display the link through a selectable button that, when activated, displays the list of podcasts produced by the radio broadcaster.

18. The computer program product of claim 15, further configured to:
distribute a program of the radio broadcaster as the podcast;
associate a unique Content ID with the program for linking the podcast;
include Content IDa “content Id” in live data object published to the user, such that the live data object is received with both the Publisher ID and the Content ID; and
display a first selectable button to all podcast produced by the radio broadcaster and a second selectable button linking directly to the podcast archive for the currently playing broadcast program.

19. The computer program product of claim 18, wherein associating the unique Content ID with the program further comprises:
checking the user device for a list of linked podcasts to retrieve the Content ID for selected podcast; and
adding the Content ID to a software that publishes the live data to a data pipeline collector, such that the data pipeline collector receives a live data event and persists the Content ID through a live data pipeline before publishing it in the live data object.

20. The computer program product of claim 18, wherein associating the unique Content ID with the program further comprises:
receiving non-playing metadata from the radio broadcaster with the program name when the program starts; and
matching the program name with the podcast in the broadcaster's catalog.
